(19) United States
(12) Patent Application Publication
(10) Pub. No.: US 2002/0105185 A1
(43) Pub. Date: Aug. 8, 2002

(54) Digital messenger greeting card

(76) Inventor: LaVelton Cobb, Newport News, VA (US)

Correspondence Address: LaVelton Cobb, 479 Nelson Dr. #21, Newport News, VA, 23601, US

(21) Appl. No.: 09/775,993

(22) Filed: Feb. 5, 2001

(51) Int. Cl. B42D 15/00

(52) U.S. Cl. 283/117

(57) ABSTRACT

A digital messenger greeting card with a miniature digital recording device affixed to its surface will record personal audible messages from the sender, physically or via the Internet. This digital recording device uses solar cells as a power source for automatic playback of recorded messages when energized by light, to further miniaturize recording device for a proper fitting inside greeting card, and to provide environmental safety.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE

Not Applicable

### BACKGROUND OF THE INVENTION

This invention relates to greeting cards. Presently, greeting cards are limited in their ability to convey personal messages to the recipient. Greeting cards ordered via Internet lack personal connection between sender and recipient because there is nothing to replace memorable handwritten messages. Therefore, a more suitable method of rending affection needs to be incorporated.

### BRIEF SUMMARY OF THE INVENTION

The feature of the present invention is to provide a more personal way of sending messages with greeting card. Audible messages can be recorded to create that personal connection only the voice of a loved one can convey.

Another feature of the present invention is the ability to create that personal connection via the Internet through service offered by web site for the busy people who do not have the time to shop for greeting cards in stores.

An object of the present invention is to have a miniature digital recording device affixed to a greeting card, powered by solar cells, to playback recorded messages instantly when the recipient opens the card for viewing, regardless if the card is ordered via Internet or purchases from a store.

### BRIEF DESCRIPTION OF THE SEVERAL VIEWS OF THE DRAWING

FIG. 1 is the viewing from inside of the greeting card, displaying the different components necessary for the recording device to operate.

FIG. 2 is the side view of the greeting card, illustrating how the speaker will protrude through the front surface, enabling the card to close properly.

### DETAILED DESCRIPTION OF THE INVENTION

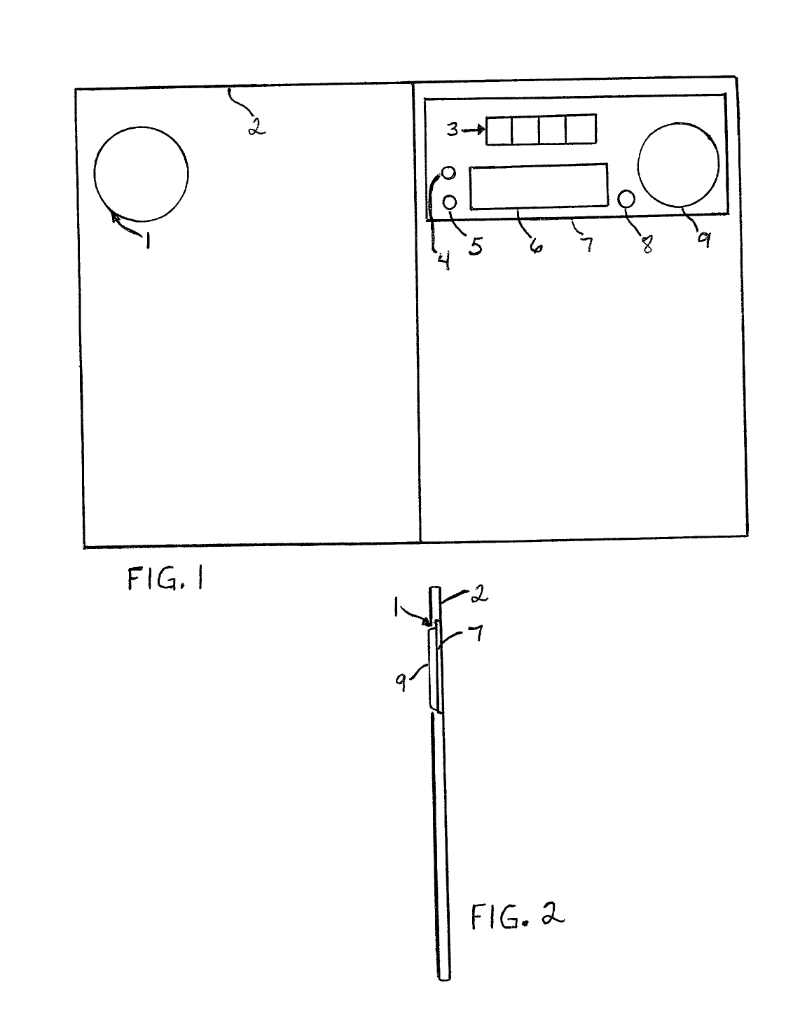

Referring no to FIG. 1, a greeting card 2 is illustrated including a miniature digital recording device connected to circuit board platform 7, which is pasted inside the card on the surface by glue. Solar cells 3 are mounted in connection with the circuit board platform 7, and will cause the digital recorder to begin automatic playback when light energizes the solar cells 3. The record button 4 is mounted on the circuit board platform 7, and allows audible messages to be saved to the digital circuit 6 when activated by depressing. The erase button 5 is mounted on the circuit board platform 7, and allows recorded messages to be deleted from the digital circuit 6 when activated by depressing. The digital circuit 6 contains the electrical components necessary to record personal messages. The mic 8 is mounted on circuit board platform 7, and changes audible messages into electrical signals to be stored in the digital circuit 6. The speaker 9 is mounted on circuit board platform 7, and converts the electrical signals into audio signals when the solar cells 3 are energized by light, and the recorded message is heard.

Referring to FIG. 2, a hole or inflated surface area 1 is illustrated in a side view of the greeting card 2. The speaker 9 protrudes through the hole or into an inflated area on the front surface so the greeting card 2 is folded properly and neatly.

What I claim as my invention is:

1. A greeting card with a miniature digital recording device affixed to its surface, for recording personal audible messages physically or via the Internet.

2. A digital recording device using solar cells as a power source for automatic playback of recorded messages when energized by light, and to further miniaturize recording device for a proper fitting inside the greeting card.
